(19) United States
(12) Patent Application Publication
(10) Pub. No.: US 2005/0106523 A1
(43) Pub. Date: May 19, 2005

(54) Rotary tubular kiln

(76) Inventors: Gaston F.V. Vangilbergen, Gelsenkirchen (DE); Harry F. Werner, Essen (DE)

Correspondence Address: FAY, SHARPE, FAGAN, MINNICH & MCKEE, LLP, 1100 SUPERIOR AVENUE, SEVENTH FLOOR, CLEVELAND, OH, 44114, US

(21) Appl. No.: 10/774,159

(22) Filed: Feb. 6, 2004

(30) Foreign Application Priority Data
Feb. 8, 2003 (DE) 103 05 147.3

(51) Int. Cl. F27B 7/00

(52) U.S. Cl. 432/103

(57) ABSTRACT

A longitudinal sealing (20), which, as a rule, extends below the rotating tube (30), is proposed to increase the heating efficiency in a rotary tubular kiln, in which a rotating tube (30) is surrounded, like a bowl, by a heating tunnel (32) and is indirectly heated by a heating medium. It is designed in the shape of a separation wall between the entry side (38) and the exit side (40) for the heating medium in the heating tunnel and consists of a rigid part (22) and a flexible part (24), situated thereon and adaptable to the rotating tube profile.

The invention under consideration refers to a rotary tubular kiln with a longitudinal sealing within a bowl-shaped heating tunnel surrounding a rotating tube which can be heated from the outside according to the preamble of claim 1, and a method for the production of such a longitudinal sealing according to the preamble of claim 7.

### BACKGROUND OF THE INVENTION

In rotary tubular kilns, high temperatures are usually used. The rotating tube can, to this end, be heated indirectly to the desired temperature with a heating medium (such as hot gas or hot air), in order to reach, in the interior of the rotating tube, the sufficiently high temperatures (several 100° C., in part >1000° C.) for chemical processes or other desired processes taking place therein. To this end, the rotating tube is usually surrounded by a heating tunnel, as shown, schematically, in FIG. 1, which shows a schematic cross-section through a rotary tubular kiln, according to the state of the art. The heating tunnel 12, surrounding like a housing the rotating tube 10 which turns in the direction of the arrow C (or in the opposite direction), has several burners 14 on its entire length, which indirectly heat the rotating tube, and gas outlets 16. A heating medium, such as hot gas, is introduced through the gas inlets 14A, the medium flows around the circumference of the rotating tube (also called rotating drum) and thus heats it. The gas can flow around both the underside of the rotating tube (as shown by arrow A) as well as the upper side (as shown by arrow B). The efficiency with a flow on the upper side is much greater, because the residence time of the gas on the surface of the rotating tube is longer and thus more time remains for a heat exchange. Moreover, a larger surface fraction of the rotating tube can receive the flow. Since it is possible for a part of the gas, however, to flow around the underside of the rotating tube, this results in an efficiency loss, since with this flow, the heat exchange is clearly less. This is also so if one provides a narrow site in the form of a slit D on the underside of the rotating tube. In this case, the flow would move along arrow A′.

The rotating tube in FIG. 1 is shown circular, schematically. This does not correspond to reality however. Since such a rotating tube extends over several meters, in part up to 100 m, it is technically almost impossible to guarantee a completely round profile over this entire distance. Furthermore, the rotating tube has a certain imbalance.

### THE INVENTION

Therefore, the problem is to create a rotary tubular kiln, which guarantees a more efficient heat exchange with outside heating, taking into consideration the described characteristics of the rotating tube.

To solve this problem a rotary tubular kiln with the features of claim 1 is proposed. Accordingly, the invention is based on the basic idea of creating a longitudinal sealing, preferably extending below the rotating tube, for a rotary tubular kiln, in which a rotating tube is surrounded bowl-like by a heating tunnel; the sealing has a rigid part and a flexible part. In this way, the flow around both sides with the heating medium—that is, an almost complete thermal short circuit—if not actually complete—is prevented. The flexible part of the longitudinal sealing, which preferably lies constantly against the rotating tube, is able to adapt to the imbalance and/or profile change of the rotating tube and thus to guarantee an essentially impermeable longitudinal sealing of the rotating tube for the heating tunnel wall. This longitudinal sealing has a particularly favorable effect on the heat passage through the rotating tube wall, since it constantly experiences a brush-like cleaning. Such a longitudinal sealing can be produced by the method described in claim 7.

By means of a rotary tubular kiln, designed in accordance with the invention, it is possible, among other things, to lower the needed temperature difference between the temperature of the heating medium and the desired interior temperature of the rotating tube, since now the heat exchange takes place with a higher efficiency. Thus, there is a savings in energy. On the other hand, the rotating tube experiences less thermal load. Also, new possibilities arise from this in the selection of the kiln wall material.

The aforementioned and the claimed components, to be used in accordance with the invention and described in the embodiments, are subject to no special exceptional conditions in their size, shaping, material selection, and technical constellation, so that the selection criteria known in the application domain can be used without reservation.

Other details, features, and advantages of the object of the invention can be deduced from the dependent claims and (except for FIG. 1) from the following description of the pertinent drawings, in which—by way of example—embodiments of the rotary tubular kiln, in accordance with the invention, are shown.

The figures in the drawings show the following:

### BRIEF DESCRIPTION OF THE DRAWINGS

FIG. 1, an indirectly heated rotary tubular kiln, according to the state of the art, in schematic cross-sectional view,

FIG. 2, a rotary tubular kiln, in accordance with the invention in vertical view, along line II-II according to FIG. 4, schematically;

FIG. 3, the same rotary tubular kiln, in vertical section, along line III-III according to FIG. 2 (in section); and

FIG. 4, the same rotary tubular kiln, in horizontal section, along the line IV-IV, according to FIG. 2 (in sections).

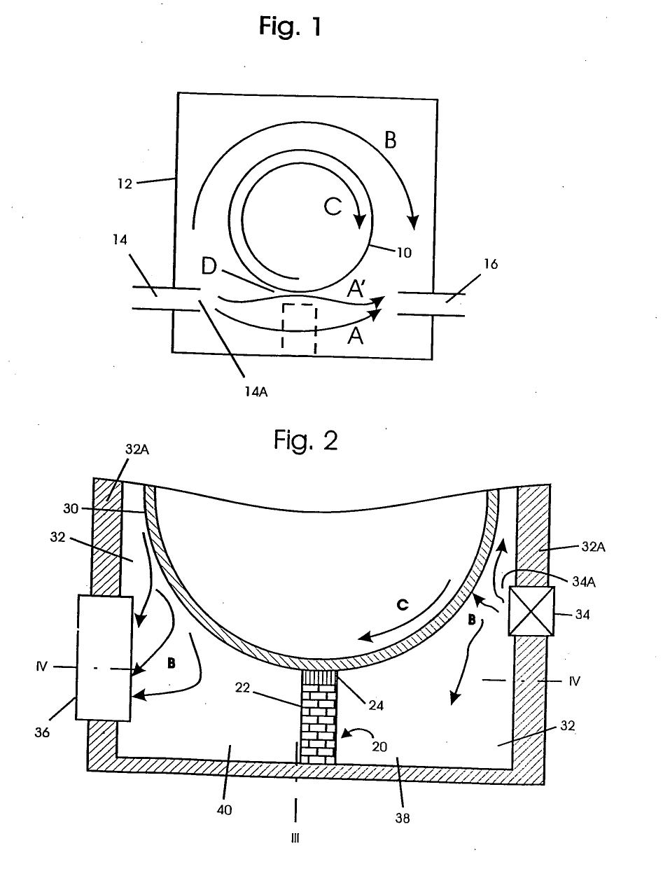

### PREFERRED EMBODIMENT

As can be seen from FIG. 2, a rotary tubular kiln, in accordance with the invention, comprises a rotating tube 30, which can turn within an approximately bowl-shaped, surrounding, stationary heating tunnel 32, wherein the heating tunnel surrounds the rotating tube, as a rule, on a substantial part of its length. The heating tunnel wall 32A has at least one inlet 34 for a heating medium (such as hot air or hot gas), and at least one outlet 36. The inlet and outlet are, as shown in FIG. 4, and in this respect, preferably shaped as longish recesses or openings of the heating tunnel, arranged on the side walls; these can also be in the form of connections or inlet tubes provided in a tunnel wall.

Usually, the rotating tube receives a flow of heating medium on its circumference and its entire length. The essential direction of flow of the heating medium is thereby in the direction of flow arrows B—that is, perpendicular to the rotating tube axis. The heating can take place both in, as well as contrary to, the rotating direction.

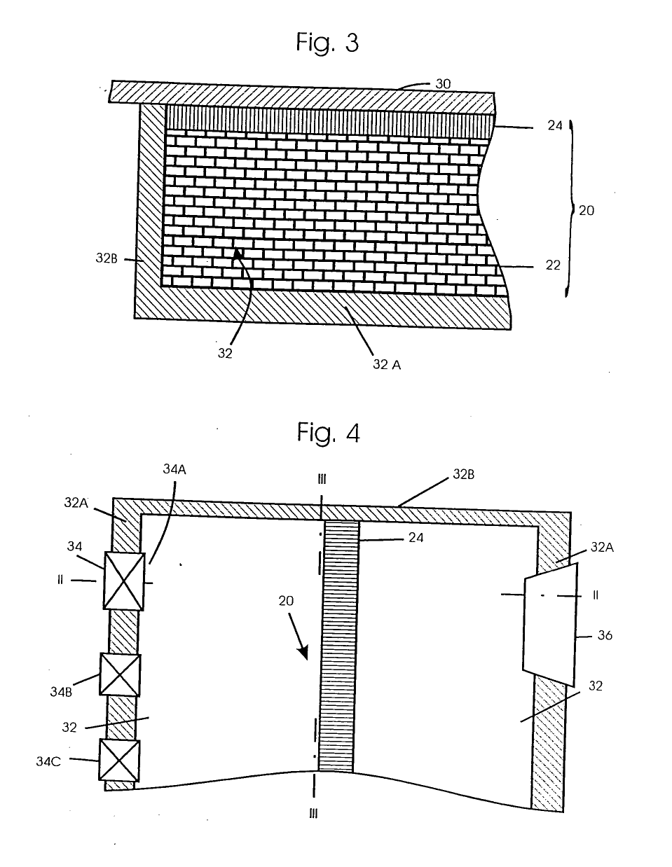

Usually, the heating tunnel 32, formed between the tunnel wall 32A and rotating tube 30, is sealed off with respect to the front side—among other things, in order to prevent an escape of the heating medium except through the outlet 36 (FIG. 3). The rotating tube can be completely surrounded by the heating tunnel or also laterally project over it.

The longitudinal sealing 20 is essentially found below the rotating tube. It looks like the embodiment according to FIGS. 2-4 and in this respect, preferably as a separation wall between the entry side 38 and the exit side 40 of the heating tunnel 32. The longitudinal sealing 20 consists of a rigid part 22 and a flexible part 24 found thereon. In the simplest case, the longitudinal sealing 20 consists of a flat, long wall with one or more flexible sealing elements placed thereon. The wall preferably extends along the full length of the heating tunnel 32 and joins the front walls 32B of the same, as can be seen from FIG. 3 and 4. Thus, a front-side flowing around of the longitudinal sealing by the heating medium is prevented.

As indicated in FIG. 2, the longitudinal sealing 20 in this embodiment can have a width of approximately 10-20% of the diameter of the rotating tube. The width of the longitudinal sealing, however, can also be selected smaller or larger, depending on the requirement.

The rigid part 22 preferably consists of brickwork. However, any other rigid or refractory material, which withstands the temperatures that appear in the heating tunnel can be taken into consideration also. As indicated in FIG. 2, the rigid part 22 can extend near the rotating, tube 30 as long as it is not seized by it when the rotating tube turns. In building the rigid part, one should be aware that the rotating tube will not rotate precisely during the operation of the kiln because of the previously described lack of precision in the rotating tube profile and because of imbalances.

The flexible part 24 is found on the rotating tube-side end of the rigid part 22. It is preferably made of a material which is so flexible that it is adapted to the inaccuracies of the rotating tube profile when the rotating tube turns. Moreover, it should withstand the temperatures which appear within the heating tunnel. Preferably, the flexible part is predominantly made of ceramic fibers.

FIGS. 3 and 4 show various views of a preferred longitudinal sealing. As can be seen from these figures, the flexible part preferably consists of strips and/or strip packets of a flexible material joined to one another. They are preferably placed at a right angle to the rotating tube axis, which requires a certain minimum thickness of the longitudinal sealing 20. This arrangement guarantees, on the one hand, an improved sealing and, on the other hand, a higher service life of the sealing. To increase the tightness, the individual strips and/or strip packets can also be cemented with one another or otherwise affixed to one another. The flexible part 24 is preferably produced by pressing in individual strips and/or strip packets between the rigid part 22 and the rotating tube 30. Depending on the need, it is connected with the rigid part 22, as, for example, by cementing. As particularly preferred, the individual strips and/or strip packets are compressed vertically and in their stacking direction. This guarantees that the sealing functions satisfactorily even after long operation and a corresponding wear. Furthermore, this prevents individual parts of the longitudinal sealing from being removed from their specific position by the rotating movement of the rotating tube.

As shown in FIG. 4 and in this respect preferred, several burners 34 can be opposite only one gas outlet 36, as is known from the state of the art. In this case, the direction of flow of the heating medium, which escapes from the burners 34C, at a distance from the gas outlet, will take place not only along the circumference of the rotating tube but rather also diagonally, in the direction of the gas outlet 36. A longitudinal sealing, in accordance with the invention, has a particularly favorable effect here, because in this way, it can be guaranteed that a substantial part of the heating medium flows around the rotating tube at least until it reaches the upper side of the rotating tube, instead of immediately being suctioned in the direction of the gas outlet 36 because of the diagonal flow.

In a preferred embodiment, the strip packet consists of 25 mm-thick ceramic fiber mats which are at least 75 mm high and approximately 34.5 cm wide (KT 1430° C., RG ca. 200 kg per square meter), which are compressed to 20 mm. If desired, several strips can also be pressed in, as strip packets, above one another, between the rigid part 22 and the rotating tube 30. By pressing, it is possible to influence the flexibility of the flexible part 24. It is also possible to first place a somewhat less flexible ply on the rigid part 22 and on it, in turn, a more flexible material. In tile same way, of course, the rigid part 22 can also consist of several plies or layers of different materials, on and/or next to one another.

However, it may also be desired for several strips, which are lying next to one another and are made of flexible material, to run parallel to the longitudinal sealing wall. This is particularly advantageous if the flexible part on the inlet side of the heating tunnel is to have other material characteristics than on the outlet side—for example, because of the different temperatures. In this case, the pressing-in process would have to be correspondingly modified. Here too, several plies of flexible material would have to be taken into consideration.

Already in its production, the flexible part is adaptable to the rotating tube outer surface in that the flexible part 24 is produced by pressing in strips and/or strip packets between the rigid part 22 and the rotating tube 30. Thus, inaccuracies and/or fluctuations in the rotating tube profile can be taken into consideration—for example, if a rotating tube has, at one site, a somewhat greater outside diameter (perhaps due to a welding seam or something similar).

### List of reference symbols

10 Rotating tube
12 Heating tunnel
14 Burner
14A Inlet
16 Outlet
20 Longitudinal sealing
22 Rigid part
24 Flexible part
30 Rotating tube
32 Heating tunnel
32A Heating tunnel wall
32B Heating tunnel front wall
34 Burner
34A Inlet
34B Burner
34C Burner
36 Outlet
38 Entry side of the heating medium
40 Exit side of the heating medium
A Flow arrow
A′ Flow arrow
B Flow arrow
C Rotation direction
D Slit

1. Rotary tubular kiln with a longitudinal sealing (20) in the form of a separation wall within a heating tunnel (32) having a tunnel wall (32A), which is bowl-shaped and surrounds an externally heatable rotating tube (30) having an outside surface, said longitudinal sealing extends between said tunnel wall (32A) and the rotating tube outside surface, preferably below the rotating tube, and is disposed between an entry side (38) and an exit side (40) of the heating medium in the heating tunnel, wherein said separation wall consists of a rigid part (22) at a distance from said rotating tube, and a flexible part (24), close to the rotating tube outside surface.

2. Rotary tubular kiln according to claim 1, characterized in that the rigid part (22) consists of brickwork, and the wall crown consists of the flexible part (24).

3. Rotary tubular kiln according to claim 1 or 2, characterized in that the flexible part (24) is made of ceramic fibers.

4. Rotary tubular kiln according to one of claims 1 to 3, characterized in that the flexible part (24) consists of strips, joined to one another, perhaps by cementing, and made of an elastic, especially compressible, material.

5. Rotary tubular kiln according to claim 4, characterized in that the strips form at least one stack.

6. Rotary tubular kiln according to claim 4 or 5, characterized in that the strips of the elastic material extend essentially perpendicular, relative to the rotating tube axis.

7. Method for the production of a longitudinal sealing for a rotary tubular kiln, in particular, with the features of one of claims 1 to 6, characterized in that the flexible part of the sealing consists of strips of an elastic material, joined to one another, which are introduced between a rigid separation wall and the rotating drum, by pressing in individual strips or strip packets.

8. Method according to claim 7, characterized in that the strips or strip packets extend essentially perpendicular, relative to the rotating tube axis and are compressed in a stack direction parallel to the rotating tube axis.
